(19) United States
(12) Patent Application Publication
(10) Pub. No.: US 2013/0063031 A1
(43) Pub. Date: Mar. 14, 2013

(54) Control Apparatus for a Circuit Arrangement for Operating a Light Source, as well as a System Comprising a Circuit Arrangement and a Circuit Arrangement, as well as a Method for Operating a Light Source

(71) Applicant: Thomas Pollischansky, Munchen (DE)

(72) Inventor: Thomas Pollischansky, Munchen (DE)

(21) Appl. No.: 13/698,918

(22) PCT Filed: Mar. 21, 2011
(86) PCT No.: PCT/EP2011/054232

§ 371 Date: Nov. 19, 2012

(30) Foreign Application Priority Data
May 19, 2010 (DE) 10 2010 029 095.5

(51) Int. Cl. H05B 37/02; H01J 13/32; H05B 35/00

(52) U.S. Cl. 315/113; 315/210; 315/182; 315/201

(57) ABSTRACT

A control apparatus for at least one circuit arrangement for operating fluorescent lamps and LEDs. Switching can occur between operation of the fluorescent lamps and LEDs via a control input.

### TECHNICAL FIELD

The present invention relates to a control apparatus for at least one circuit arrangement for operating at least one light source to set a first and a second illumination status, the control apparatus comprising: a first connection for coupling to a first phase of an alternating current network, a second connection for coupling to a neutral conductor of the alternating current network, at least one control output for coupling to a driver circuit for operating the at least one light source, a third and fourth connection for coupling to a switching device, the third connection being coupled to the first connection or the second connection, the fourth connection being coupled to the second connection or the first connection, an evaluating device having at least one input and at least one output, the at least one input of the evaluating device being coupled to the connection of the third or fourth connection that is not coupled to the first connection, the at least one output of the evaluating device being coupled to the at least one control output, the evaluating device being configured to provide a switch-on signal at the at least one output thereof to set the first illumination status at least if the mean value of the signal applied to the input thereof is below a first pre-settable threshold value.

The invention also relates to a system comprising a first circuit arrangement for operating at least one light source, a second circuit arrangement for operating at least one discharge lamp and a control apparatus of this type.

Finally, the present invention relates to a method for operating at least one light source with a system comprising a control apparatus having a first connection for coupling to one phase of an alternating current network, a second connection for coupling to a neutral conductor of the alternating current network, at least one control output for coupling to a driver circuit for operating the at least one light source, a third and fourth connection for coupling to a switching device, wherein the third connection is coupled to the first connection or the second connection, wherein the fourth connection is coupled to the second or the first connection, an evaluating device having at least one input and at least one output, the at least one input of the evaluating device being coupled to the connection of the third or fourth connection which is not coupled to the first connection, wherein the at least one output of the evaluating device is coupled to the at least one control output, the evaluating device being configured to provide a switch-on signal at the at least one output thereof to set the first illumination status if the mean value of the signal applied to the input thereof is below a first pre-settable threshold value, and a first circuit arrangement with a first connection to couple to one phase of an alternating current network, a second connection which is coupled to the second connection of the control apparatus, a first rectifier with a rectifier input and a rectifier output, the rectifier input being coupled to the first and second connection of the first circuit arrangement, at least one first driver circuit having at least one first control input which is coupled to the at least one control output of the control apparatus, and at least one output for coupling to the at least one light source.

### PRIOR ART

The present invention relates to a problem such as that which arises, for example, in operating devices of hybrid lamps which are configured to operate at least one discharge lamp, in particular a fluorescent lamp as well as at least one LED. In operating devices known from the prior art for hybrid lamps, the at least one LED and the at least one discharge lamp are switched on and off separately from one another.

Operation with at least one LED, in the context of the present invention, is designated the first illumination status and operation with the at least one discharge lamp is designated the second illumination status. Although the invention is described below using the example of hybrid lamps, it can also be used for the operation of a type of light source, for example, fluorescent lamps, in which a first illumination status correlates to a first dimming setting and a second illumination status correlates to a second dimming setting.

From the prior art it is known to use a “touch-dim input” to control the dimming process. The control process is linked via a switching device to one phase of an alternating voltage network. A touch-dim input of this type could, in principle, be used for switching over between the first and second illumination status. In practice, however, problems have arisen when further operating devices are coupled to the switching device. In other words, if at least one further operating device is coupled, in parallel with the first operating device, to the switching device unwanted flickering of the at least one light source of the first operating device occurs. The expression “circuit arrangement” as used in the present application should be understood, in particular, to mean operating devices of this type.

### DESCRIPTION OF THE INVENTION

The object of the present invention is therefore to develop a control apparatus of this type so that switching over from a first illumination status to a second illumination status, and vice versa is enabled without unwanted flickering even if further operating devices are coupled, in parallel with the first operating device, to a switching device for triggering the switching-over procedure. A further object of the invention lies in providing a corresponding system comprising a first circuit arrangement for operating at least one light source, a second circuit arrangement for operating at least one discharge lamp and a control apparatus of this type. Furthermore, it is intended to provide a corresponding method for operating at least one light source.

These objects are achieved by a control apparatus having the features of claim 1, a system having the features of claim 8 and a method having the features of claim 10.

The present invention is based on the concept that by coupling further circuit arrangements for operating further discharge lamps to the switching device, the signal evaluated by the evaluation device at the output thereof is corrupted. In particular, due to the input capacitance of the further circuit arrangements, a voltage level can be generated at the input of the evaluating device which is falsely interpreted as a switch-on signal for the at least one discharge lamp of the first circuit arrangement, that is, the circuit arrangement for operating the at least one light source.

The present invention makes use of the fact that, as detailed investigations have shown, a voltage level generated by a further circuit arrangement at the input of the evaluating circuit can however be recognized in that the mean value of said voltage level falls more or less continuously as a result of the charging up of the intrinsic capacitance of the further circuit arrangement. If a fall of this type is detected, it is concluded that the voltage level generated at the input of the evaluating device does not originate from the switching device, but from the further circuit arrangement. After verification of a fault of this type, the light source of the first circuit arrangement therefore remains in the first illumination status.

According to the invention, the evaluating device is therefore also configured to provide a control signal at the at least one output thereof to set the second illumination status if a) the mean value of the signal applied to the at least one input of said evaluating device is above the first pre-settable threshold value at a first and a second pre-settable time point, and b) the difference between the amplitude of the mean value at the first pre-settable time point and at the second pre-settable time point is less than or equal to a second pre-settable threshold value. Said second pre-settable threshold can be, for example, 0V.

By means of this measure, it can be unambiguously concluded whether a switch-over signal has been issued by the switching device for the at least one light source coupled to the first circuit arrangement or whether it is merely a fault that has occurred, caused by one of the further circuit arrangements.

A control apparatus according to the invention therefore provides the possibility of coupling a plurality of circuit arrangements to the switching device and nevertheless enabling reliable switching over between a first illumination status and a second illumination status for the first circuit arrangement.

The driver circuits mentioned in the context of the present invention can also be, in particular, an electronic ballast device.

As mentioned above, the first illumination status can correspond to a first dimming setting of the at least one light source and the second illumination status can correspond to a second dimming setting of the at least one light source.

Alternatively, the first illumination status can correspond to the switching on of at least one LED and the second illumination status can correspond to the switching on of at least one discharge lamp.

The present invention therefore enables, for example, switching-over from LED operation to the operation of a plurality of discharge lamps—coupled to the first circuit arrangement or further circuit arrangements—by a control line. The invention also enables the switching-over of the light source coupled to the first circuit arrangement from a first illumination status to a second illumination status, the second illumination status being associated with the switching on of the light sources of the further circuit arrangements, which can be, in particular, discharge lamps.

The formulation that the third connection is coupled to the first connection or to the second connection—and conversely the fourth connection to the second or the first connection—takes account of the circumstance that it is unimportant for the present invention which of the connections of the circuit arrangement is coupled to a phase of the alternating current network and which is coupled to the neutral conductor of the alternating current network. The invention functions independently thereof.

A particularly preferred embodiment is distinguished in that the evaluating device is configured to provide a signal at the at least one output thereof to preheat the at least one discharge lamp, if it has been determined at the first pre-settable time point that the mean value of the signal applied to the at least one input thereof is above the first pre-settable threshold value. By means of this measure and the suitable choice of the first and second pre-settable time points, the possibility is created of previously pre-heating the discharge lamp that is coupled to the first circuit arrangement sufficiently so that, at the second pre-settable time point, that is, at the time point at which it is determined whether the signal level at the input of the evaluating device has been generated by operation of the switching device or by a fault in the at least one further circuit arrangement, switching over from LED operation to discharge lamp operation without a dark phase can take place. The result this produces for the user is that no interruption in the illumination is perceptible. Direct switching-over, for example, by a movement sensor is thereby made possible.

Preferably, the evaluating device is further configured, at least for the time period during which the evaluating device provides a signal at the at least one output thereof for pre-heating the at least one discharge lamp, to provide at the at least one output of said evaluating device a signal for switching on the at least one LED. By this means, switching-over between LED operation and discharge lamp operation without interruption is guaranteed.

Preferably, the first and second time point are selected so that the difference between the first and second pre-settable time points represents 80% to 100% of the nominal preheat duration of the at least one discharge lamp. By this means, it is ensured that—following evaluation of the signal at the input of the evaluating device—the discharge lamp can be immediately switched on, that is ignited.

Preferably, a diode is coupled in series between the connection of the third or fourth connection, which is not coupled to the first connection and the at least one input of the evaluating device. By this means, the negative half-waves of the input voltage are filtered so that the mean value formation is facilitated.

A preferred embodiment of the system according to the invention is distinguished in that the first circuit arrangement comprises a first connection for coupling to one phase of an alternating current network, a second connection which is coupled to the second connection of the control apparatus, a first rectifier with a rectifier input and a rectifier output, wherein the rectifier input is coupled to the first and second connection of the first circuit arrangement and at least one first driver circuit with at least one control input which is coupled to the at least one control output of the control apparatus, and at least one output to couple to the at least one light source, wherein the second circuit arrangement comprises a first connection which is coupled to the connection of the third or fourth connection of the control apparatus which is not coupled to the first connection of the control apparatus, a second connection which is coupled to the second connection of the control device, a second rectifier with a rectifier input and a rectifier output, wherein the rectifier input is coupled to the first and the second connection of the second circuit arrangement and at least one second driver circuit having at least one output to couple to at least one further discharge lamp.

The method according to the invention is characterized by the following steps: initially, in step a) it is tested whether the mean value of the signal applied to the at least one input of the evaluating device at a first or a second pre-settable time point is above a first threshold value. If this is affirmed, in step b) it is tested whether the difference between the amplitude of the mean value at the first pre-settable time point and at the second pre-settable time point is below a second pre-settable threshold value. If this is also affirmed, in step c) a control signal is provided at the at least one output of the evaluating device to set the second illumination status.

As previously stated, the at least one light source can be operated in the first illumination status in a first dimming setting and in a second illumination status in a second dimming setting.

Alternatively, during the first illumination status, at least one LED, and, during the second illumination status, at least one discharge lamp can be switched on.

Preferably, if in step a) it is determined that at the first pre-settable time point, the mean value of the signal at the at least one input of the evaluating device is above the first threshold value, a preheating signal is provided at the at least one output of the evaluating device for the at least one discharge lamp.

Further preferably, at least during the time period for which the evaluating device provides, at the at least one output thereof, a preheating signal to the at least one discharge lamp, a signal for switching on the at least one LED is provided at the at least one output of the evaluating device.

If the mean value of the signal applied to the at least one input of the evaluating device during the preheating duration of the at least one discharge lamp falls below the first pre-settable threshold value, the preheating of the at least one discharge lamp is ended.

Preferably, the preheating of the at least one discharge lamp is also ended if the difference of the amplitude of the signal at the at least one input of the evaluating device at the first pre-settable time point and at the second pre-settable time point during the preheating duration of the at least one discharge lamp is above the second pre-settable threshold value.

Further preferably, following switching on, that is, ignition, of the at least one discharge lamp, the at least one LED is switched off.

Finally, the at least one discharge lamp is switched off and the at least one LED is switched on if the mean value of the signal at the at least one input of the evaluating device falls below the first pre-settable threshold value.

Further preferred embodiments are disclosed in the subclaims.

The preferred embodiments described in relation to the control apparatus according to the invention and the advantages thereof apply similarly, where relevant, to the system and the method according to the invention.

### BRIEF DESCRIPTION OF THE DRAWINGS

Exemplary embodiments of the present invention will now be described in greater detail making reference to the drawings, in which:

FIG. 1 is a schematic representation of an exemplary embodiment of a system according to the invention;

FIG. 2 is a schematic representation of the variation over time of the signal S_{E} of FIG. 1;

FIG. 3 is a schematic representation of the logic sequence diagram of a first exemplary embodiment of the method according to the invention; and

FIG. 4 is a schematic representation of the logic sequence diagram of a second exemplary embodiment of the method according to the invention.

### PREFERRED EMBODIMENT OF THE INVENTION

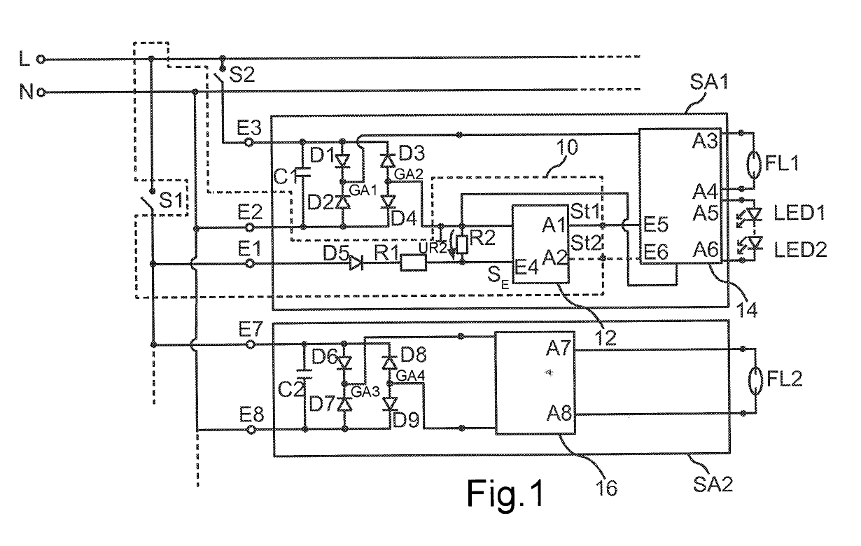

FIG. 1 shows a schematic representation of an exemplary embodiment of a system according to the invention, comprising a control apparatus 10 according to the invention. Said system comprises a switching device S1 which can be, for example, an on/off switch or a movement sensor, the first connection thereof being coupled to a phase L of an alternating current network and the second connection thereof being coupled to the input E1 of a first circuit arrangement SA1. In the present case, the control apparatus 10 is shown as part of the circuit arrangement SA1 in order to make use also of elements of the circuit arrangement SA1 for the control apparatus 10, which results in an economical configuration. The control apparatus 10 could easily be configured separately, that is, outside the circuit arrangement SA1.

The circuit arrangement SA1 is coupled via a second connection E2 to the neutral conductor N of the alternating current network. Without impairing the function of the invention, the connection of the switch S1 coupled to the phase L of the alternating current network in FIG. 1 could be coupled to the neutral conductor N of the alternating current network and the input E2 of the circuit arrangement SA1 could accordingly be coupled to the phase L of the alternating current network.

The circuit arrangement SA1 can also be coupled via a switch S2 to the phase L of the alternating current network. The switch S2 is therefore coupled on one side to the phase L and, on the other side, to an input E3 of the circuit arrangement SA1. Coupled between the inputs E2 and E3 of the circuit arrangement SA1 is a capacitor C1. The input of a rectifier which comprises the diodes D1, D2, D3, D4 is coupled in parallel with the capacitor C1. The rectifier has a first rectifier output connection GA1 and a second rectifier output connection GA2. The rectifier output connection GA2 provides the reference potential for the further components of the circuit arrangement SA1.

Coupled in series with the input E1 is a diode D5 and a high-resistance potential divider which comprises the ohmic resistors R1 and R2. The voltage across the tap points of the potential divider represents the input signal S_{E} of an evaluating device 12 to which said signal S_{E} is fed via an input E4.

The evaluating device 12 comprises a first output A1 and an optional second output A2, the output A1 being coupled to the control output St1 of the control apparatus 10 and the output A2 being coupled to a control output St2 of the control apparatus 10. The control output St1 is coupled to the input E5 and the control output St2 is coupled to an input E6 of a driver circuit 14 which may be, in particular, an electronic ballast unit.

The driver circuit 14 is configured to operate, between the output connections A3 and A4 thereof, at least one discharge lamp FL1 and between the output connections A5 and A6 thereof, a plurality of LEDs, LED1, LEDn. The driver circuit is coupled, for the supply thereof, to the outputs GA1, GA2 of the rectifier D1 to D4. If only one control output St1 is used, the control signals for the at least one discharge lamp FL1 and the at least one LED are transferred via one and the same control output St1. The provision of a second control output St2 offers the possibility of transferring the control signals for the at least one discharge lamp FL1 via the first control output St1 and the control signals for the at least one LED via the second control output St2.

The system of FIG. 1 also comprises a second circuit arrangement SA2 with inputs E7 and E8. The input E7 is coupled to the input E1 of the first circuit arrangement SA1, whereas the input E8 is coupled to the input E2 of the circuit arrangement SA1. Coupled between the input connections E7, E8 is a capacitor C2 to which the input of a rectifier comprising the diodes D6, D7, D8 and D9 is connected in parallel. Coupled between the outputs GA3, GA4 of the rectifier D6 to D9 is a driver circuit 16 which is configured to operate a discharge lamp FL2 connected between the output connections A7, A8 thereof.

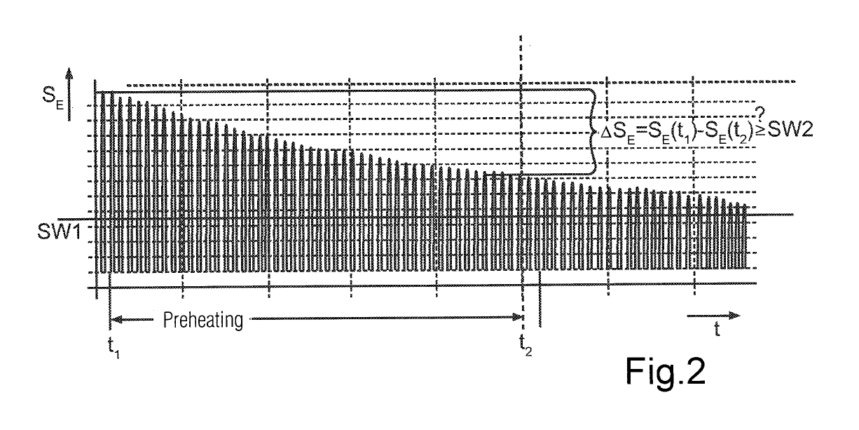

FIG. 2 shows a schematic representation of an example of the variation over time of the signal S_{E} at the input E4 of the evaluating device 12. It is evident from the chronological sequence that, as a consequence of the diode D5, the signal S_{E} comprises only the positive half-waves of the mains alternating voltage. Shown on the figure is a first threshold value SW1 which, in the present case, for clearer illustration, is not adjusted to the mean value of the signal S_{E}, but to the peak value of the respective positive mains half-waves.

As long as said peak values are above the threshold value SW1, there is reason to assume that the switch S1 has been switched on. Therefore if, at the time point t₁, it has been determined that the peak value is above the threshold value SW1, the evaluating device 12 makes available, at the output A1 thereof, a signal which causes the driver circuit 14 to preheat the discharge lamp FL1. At the time point t₂, the signal S_{E} is evaluated once again, and in the present case, it is determined that the peak value of the signal S_{E} is still above the threshold value SW1. In order to determine whether the switch S1 is actually switched on, the difference ΔS_{E} between the signal S_{E} at the time point t₁ and the signal S_{E} at the time point t₂ is found. If said difference is greater than or equal to a second threshold value SW2, wherein the second threshold value can be, for example, 0V, then the evaluating device 12 assumes that the switch S1 is actually not switched on and the signal S_{E} results rather from the intrinsic capacitance C2 of the circuit arrangement SA2.

The evaluating device 12 therefore provides no signal at the output A1 thereof to the driver circuit 14 for igniting the discharge lamp FL1. If, however, it is determined that the difference ΔS_{E} is smaller or equal to a second threshold value, the evaluating device 12 triggers the driver circuit 14 to ignite the discharge lamp FL1.

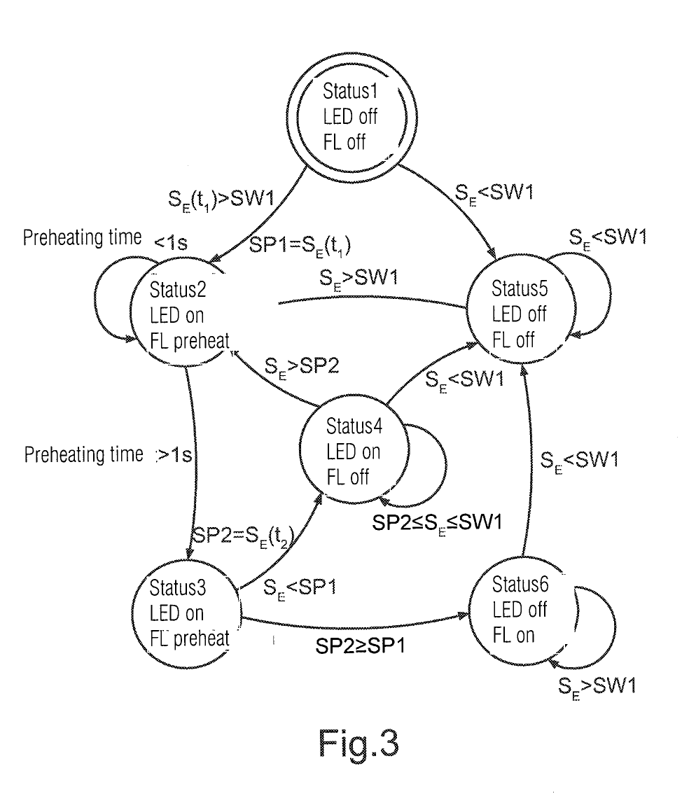

FIG. 3 shows, by way of example, in a schematic representation, an exemplary embodiment of a method according to the invention for the system shown in FIG. 1, wherein for the sake of simplicity, the threshold value SW2 has been set equal to 0V. In order to take account of tolerances, however, SW2 can also be not equal to 0V. The method begins with status 1 in which the LED and the discharge lamp FL are switched off. If it is determined that the signal S_{E} at the time point t₁ is greater than the threshold value SW1, a change over to status 2 takes place in which the LED is switched on and preheating of the discharge lamp LF is started. For as long as the preheat time is below a pre-settable time duration, for example, 1 s, the method remains at status 2. The signal S_{E} at the time point t₁ is stored in a memory as the value Sp1.

As soon as the preheat time is greater than 1s, the method changes over to status 3 in which the LED is switched on and the discharge lamp FL is further preheated. The value of the signal S_{E} at the time point t₂ is stored in the memory as the value Sp2. If it is subsequently determined that Sp2 is greater than or equal to Sp1, the method changes to status 6 in which the LED is switched off and the discharge lamp FL is ignited. The method remains in this status for as long as the signal S_{E} is greater than the first threshold value SW1. If, in status 6, the signal S_{E} falls below the threshold value SW1, the method changes to status 5 in which the LED is switched on and the discharge lamp is switched off. The method remains in this status for as long as the signal S_{E} is smaller than the threshold value SW1. Starting from status 1, the method also changes to status 5, after the system is switched on, for as long as the signal S_{E} is smaller than the threshold value SW1.

Starting from status 3, the method changes over to status 4 in which the LED is switched on and the discharge lamp FL is switched off if, in status 3, it is determined that the signal S_{E} has fallen below the value Sp1. In status 4, the method waits until the signal S_{E} has either fallen below the threshold value SW1 and then changes to status 5 or until the signal has risen above the value SP2 and then changes to status 2.

From status 5, the method changes to status 2 if, in status 2 it is determined that the signal S_{E} has risen above the threshold value SW1 again.

The method according to the invention reliably prevents unwanted switching on or flickering of the discharge lamp FL1 of FIG. 1.

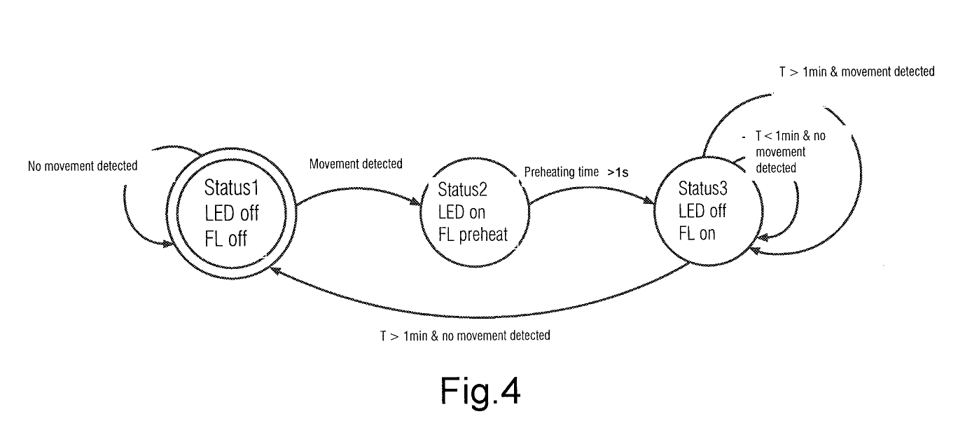

FIG. 4 shows a schematic representation of a simplified logic sequence diagram for an application using a movement sensor as the switching device S1. The method begins at status 1 with the LED switched on and the discharge lamp FL1 switched off. As long as no movement is detected, the method remains at status 1. If a movement is detected, the method changes to status 2, wherein the LED remains switched on, although the discharge lamp FL1 is preheated. If the preheating time is greater than the nominal preheating duration, which is assumed herein to be 1 s, the method changes to status 3 in which the discharge lamp FL1 is ignited, i.e. switched on and the LED is switched off. The method remains in this state for a pre-settable time, for example, 1 min if no further movement is detected. It also remains in this status for a duration of greater than 1 min if a further movement is detected. For durations of greater than 1 min and no detected movement, the method changes from status 3 back to status 1.

Although, for the sake of clarity, not shown in FIGS. 3 and 4, the discharge lamp FL2 coupled to the second circuit arrangement SA2 is operated similarly to the discharge lamp FL1 coupled to the first circuit arrangement SA1.

Rather than switching over between at least one discharge lamp and at least one LED, the control apparatus according to the invention, the system according to the invention and the method according to the invention can also be used for switching back and forth between different dimming levels in one and the same light source which is coupled to the first circuit arrangement, for example, a discharge lamp.

1. A control apparatus for at least one circuit arrangement for operating at least one light source to set a first and a second illumination status, the control apparatus comprising:
a first connection for coupling to one phase of an alternating current network;
a second connection for coupling to a neutral conductor of the alternating current network;
at least one control output for coupling to a driver circuit for operating the at least one light source;
a third and fourth connection for coupling to a switching device, the third connection being coupled to the first connection or the second connection, the fourth connection being coupled to the second connection or the first connection;
an evaluating device having at least one input and at least one output, the at least one input of the evaluating device being coupled to the connection of the third or fourth connection that is not coupled to the first connection, the at least one output of the evaluating device being coupled to the at least one control output, the evaluating device being configured to provide a control signal at the at least one output thereof to set the first illumination status at least if the mean value of the signal applied to the input thereof is below a first pre-settable threshold value,
wherein the evaluating device is further configured to provide a control signal at the at least one output thereof to set the second illumination status if
a) the mean value of the signal applied to the at least one input of said evaluating device is above the first pre-settable threshold value at a first and a second pre-settable time point, and
b) the difference between the amplitude of the mean value at the first pre-settable time point and at the second pre-settable time point is less than or equal to a second pre-settable threshold value.

2. The control apparatus as claimed in claim 1, wherein
the first illumination status corresponds to a first dimming setting of the at least one light source and the second illumination status corresponds to a second dimming setting of the at least one light source.

3. The control apparatus as claimed in claim 1, wherein
the first illumination status corresponds to the switching on of at least one LED and the second illumination status corresponds to the switching on of at least one discharge lamp.

4. The control apparatus as claimed in claim 3, wherein
the evaluating device is configured to provide a signal at the at least one output thereof to preheat the at least one discharge lamp, if it has been determined at the first pre-settable time point that the mean value of the signal applied to the at least one input thereof is above the first pre-settable threshold value.

5. The control apparatus as claimed in claim 3, wherein
the evaluating device is further configured, at least for the time period during which the evaluating device provides a signal at the at least one output thereof for pre-heating the at least one discharge lamp, to provide at the at least one output thereof, a signal for switching on the at least one LED.

6. The control apparatus as claimed in claim 3, wherein
the difference between the first and second pre-settable time point represents 80% to 100% of the nominal preheat duration of the at least one discharge lamp.

7. The control apparatus as claimed in claim 1, wherein
a diode is coupled in series between the connection of the third or fourth connection, which is not coupled to the first connection, and the at least one input of the evaluating device.

8. A system comprising a first circuit arrangement for operating at least one light source for setting a first and a second illumination status, a second circuit arrangement for operating at least one discharge lamp and a control device according to claim 1.

9. A system as claimed in claim 8,
wherein the first circuit arrangement comprises:
a first connection for coupling to one phase of an alternating current network;
a second connection which is coupled to the second connection of the control apparatus;
a first rectifier with a rectifier input and a rectifier output, wherein the rectifier input is coupled to the first and second connection of the first circuit arrangement; and
at least one first driver circuit with at least one control input which is coupled to the at least one control output of the control apparatus, and at least one output to couple to the at least one light source;
wherein the second circuit arrangement comprises:
a first connection which is coupled to the connection of the third or fourth connection of the control apparatus which is not coupled to the first connection of the control apparatus;
a second connection which is coupled to the second connection of the control device;
a second rectifier with a rectifier input and a rectifier output, wherein the rectifier input is coupled to the first and the second connection of the second circuit arrangement; and
at least one second driver circuit having at least one output to couple to at least one further discharge lamp.

10. A method for operating at least one light source to set a first and a second illumination status in a system, comprising:
a control apparatus having a first connection for coupling to one phase of an alternating current network; a second connection for coupling to a neutral conductor of the alternating current network; at least one control output for coupling to a driver circuit for operating the at least one light source; a third and fourth connection for coupling to a switching device, the third connection being coupled to the first connection or the second connection, the fourth connection being coupled to the second connection or the first connection; an evaluating device having at least one input and at least one output, the at least one input of the evaluating device being coupled to the connection of the third or fourth connection that is not coupled to the first connection, the at least one output of the evaluating device being coupled to the at least one control output, the evaluating device being configured to provide a control signal at the at least one output thereof to set the first illumination status at least if the mean value of the signal applied to the input thereof is below a first pre-settable threshold value, and
a first circuit arrangement having a first connection for coupling to one phase of an alternating current network; a second connection which is coupled to the second connection of the control apparatus; a first rectifier with a rectifier input and a rectifier output, wherein the rectifier input is coupled to the first and second connections of the first circuit arrangement; at least one first driver circuit with at least one control input which is coupled to the at least one control output of the control apparatus, and at least one output to couple to the at least one light source,
wherein the method comprises the steps of:
a) testing whether the mean value of the signal applied to the at least one input of the evaluating device is above the first threshold value at a first and a second pre-settable time point;
b) if step a) is affirmed: testing whether the difference between the amplitude of the mean value at the first pre-settable time point and at the second pre-settable time point is less than or equal to a second pre-settable threshold value; and
c) if step b) is also affirmed: providing a control signal at the at least one output of the evaluating device to set the second illumination status.

11. The method as claimed in claim 10,
wherein during the first illumination status, at least one LED; and, during the second illumination status, at least one discharge lamp is switched on.

12. The method as claimed in claim 11,
comprising the following step:
a) if, during step a), it is determined that at the first pre-settable time point, the mean value of the signal at the at least one input of the evaluating device is above the first threshold value: a preheating signal is provided at the at least one output of the evaluating device for the at least one discharge lamp.

13. The method as claimed in claim 12,
comprising the following step:
e) provision of a signal for switching on the at least one LED at the at least one output of the evaluating device at least during the time period for which the evaluating device provides, at the at least one output thereof, a preheating signal to the at least one discharge lamp.

14. The method as claimed in claim 12, comprising the following step:
f) if the mean value of the signal at the at least one input of the evaluating device during the preheating duration of the at least one discharge lamp falls below the first pre-settable threshold value: the preheating of the at least one discharge lamp is ended.

15. The method as claimed in claim 12, comprising the following step:
i) if the difference of the amplitude of the signal at the at least one input of the evaluating device at the first pre-settable time point and at the second pre-settable time point during the preheating duration of the at least one discharge lamp is above the second pre-settable threshold value: the preheating of the at least one discharge lamp is ended.

16. The method as claimed in claim 11, comprising the following step:
g) following the switching-off of the at least one discharge lamp: switching off the at least one LED.

17. The method as claimed in claim 16,
comprising the following step:
h) if the mean value of the signal at the at least one input of the evaluating device falls below the first pre-settable threshold value: the at least on discharge lamp is switched off and the at least one LED is switched on.
